(19) United States
(12) Patent Application Publication
(10) Pub. No.: US 2017/0038706 A1
(43) Pub. Date: Feb. 9, 2017

(54) WINDING DEVICE AND IMAGE FORMING DEVICE

(71) Applicant: FUJI XEROX CO., LTD., Tokyo (JP)

(72) Inventors: Susumu KIBAYASHI, Minamiashigara-shi (JP); Shigeki WASHINO, Minamiashigara-shi (JP)

(73) Assignee: FUJI XEROX CO., LTD., Tokyo (JP)

(21) Appl. No.: 15/042,959

(22) Filed: Feb. 12, 2016

(30) Foreign Application Priority Data
Aug. 3, 2015 (JP) 2015-153360
Aug. 3, 2015 (JP) 2015-153361
Aug. 14, 2015 (JP) 2015-160102

(51) Int. Cl. G03G 15/00; B65H 23/16

(52) U.S. Cl. CPC G03G 15/1615; B65H 23/044; B65H 23/1955; B65H 2801/03

(57) ABSTRACT

There is provided a winding device, including: a winding part that winds a longitudinal recording medium in which an image is formed: a suppressing member that suppresses generation of a strain in the longitudinal recording medium wound by the winding part; and an operation part that operates the suppressing member in a case where the strain in the longitudinal recording medium wound by the winding part is a threshold value or more.

### CROSS-REFERENCE TO RELATED APPLICATIONS)

This application is based on and claims priority under 35 U.S.C. 119 from Japanese Patent Application Nos. 2015-160102 filed on Aug. 14, 2015, 2015-153361 filed on Aug. 3, 2015, and 2015-153360 filed on August 3.

### BACKGROUND

1. Technical Field

This invention relates to a winding device and an image forming device.

2. Related Art

A winding device for web-like print, described in JP-A-2003-128313, winds a web-like print while shifting the web-like print to a scanning direction, and thereby the both end surfaces of the wound print are arranged to be non-uniform.

### SUMMARY

According to an exemplary embodiment of the present invention, there is provided a winding device, including: a winding part that winds a longitudinal recording medium in which an image is formed; a suppressing member that suppresses generation of a strain in the longitudinal recording medium wound by the winding part; and an operation part that operates the suppressing member in a case where the strain in the longitudinal recording medium wound by the winding part is a threshold value or more.

### DRAWINGS

Exemplaty embodiments of the present invention will be described in detail based on the following figures, wherein:

FIG. 1 shows a cross-sectional view of a resin film and the like wound by a winding shaft in a winding device according to a first embodiment of the present invention;

FIG. 2 shows a brock diagram showing a control member in the winding device according to the first embodiment of the present invention;

FIG. 3 shows a front view showing of the resin film and the like wound by the winding shaft in the winding device according to the first embodiment of the present invention;

FIG. 4 shows a front view showing of the resin film and the like wound by the winding shaft in the winding device according to the first embodiment of the present invention;

FIG. 5 shows a front view showing of the a front view showing of the resin film wound by the winding shaft, a detector and the like in the winding device according to the first embodiment of the present invention;

FIG. 6 shows a perspective view showing the winding device according to the first embodiment of the present invention;

FIG. 7 shows a construction diagram showing an image forming unit in an image forming apparatus of the first embodiment of the present invention;

FIG. 8 shows a schematic construction diagram showing the image forming apparatus of the first embodiment of the present invention;

FIG. 9 shows a front view of a resin film and the like wound by a winding shaft in a winding device of a first comparative embodiment to the first embodiment of the present invention;

FIG. 10 shows a block diagram showing a control member of a winding device according to a second embodiment of the present invention;

FIGS. 11A and 11B show a front view and a side view of a resin film and the like wound by a winding shaft in a winding device according to the second embodiment of the present invention;

FIGS. 12A and 12B show an explanation diagram of an image formed on a resin film F by using an image forming apparatus according to a third embodiment and an image density of the image;

FIG. 13 shows a flow diagram showing a flow for forming an image on the resin film F by using the image forming apparatus according to the third embodiment of the present invention;

FIG. 14 shows a perspective view showing a vicinity of a winding shaft of the image forming apparatus according to the third embodiment of the present invention;

FIG. 15 shows a front view showing a resin film and the like wound by the winding shall in the image forming apparatus according to the third embodiment of the present invention;

FIG. 16 shows a front view showing a resin fihn and the like wound by the winding shaft in the image forming apparatus according to the third embodiment of the present invention;

FIG. 17 shows a figure of an image formed on the resin film F by using the image forming apparatus according to the third embodiment of the present invention;

FIG. 18 shows a construction diagram showing an image forming part in the image forming apparatus according to the third embodiment of the present invention;

FIG. 19 shows a schematic construction diagram showing the image forming apparatus according to the third embodiment of the present invention;

FIG. 20 shows a plane view showing a state where a plurality of images is formed on a resin film by using an image forming apparatus according to the fourth embodiment in the present invention;

FIG. 21 shows a perspective view showing a jig for measuring softness of the resin film used in the image forming apparatus according to the fourth embodiment in the present invention;

FIG. 22 shows a construction diagram showing an image forming part in the image funning apparatus according to the fourth embodiment in the present invention;

FIG. 23 shows a schematic construction diagram showing the image forming apparatus according to the fourth embodiment in the present invention;

FIG. 24 shows a planer view showing a state where a plurality of images is formed on a resin film by using an image forming apparatus according to a third comparative embodiment in the present invention;

FIG. 25 shows a front view showing a state where a plurality of images is formed on a resin film by using an image forming apparatus according to the third comparative embodiment in the present invention; and

FIG. 26 shows a perspective view of a post-processing unit in an image forming apparatus according to a fourth comparative embodiment.

### DETAILED DESCRIPTION

### First Embodiment

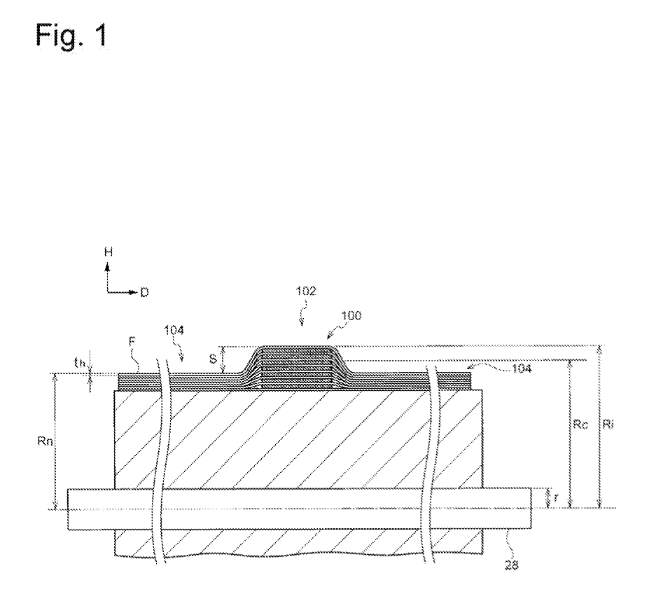

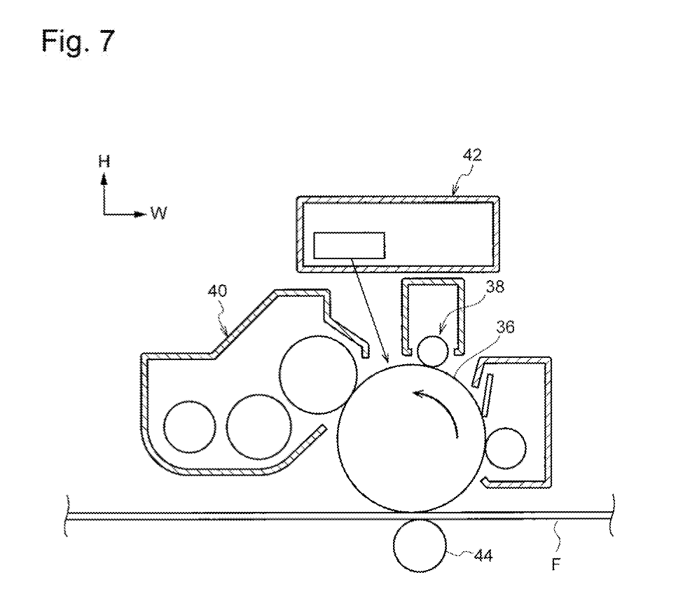

An example of a winding device and an image forming apparatus according to the first embodiment of the present invention will be explained according to FIGS. 1 to 9. The arrows H, W and D shown in the figures mean a vertical direction of the device, a width direction of the device, and a depth direction of the device, respectively.

### (Whole Construction)

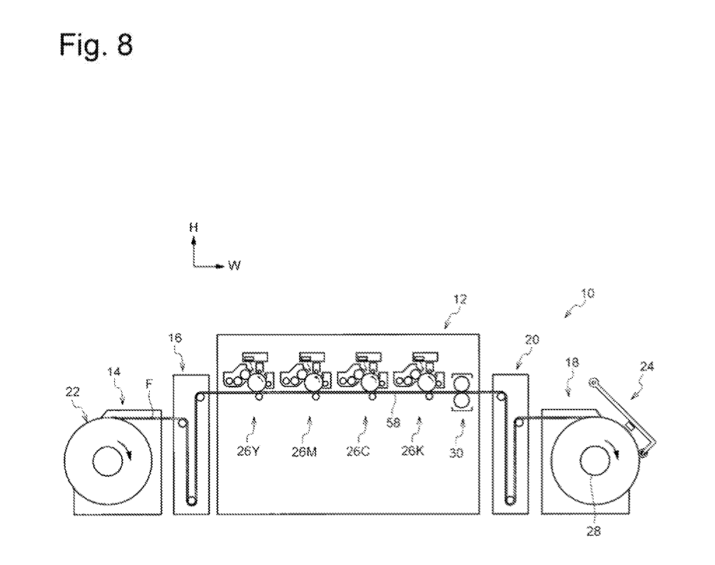

As shown in FIG. 8, an image forming apparatus 10 includes an image forming unit 12 capable of forming an image a resin film F as a longitudinal recording medium, a pre-processing unit 14 accommodating the resin film F to be fed to the image forming unit 12, and a buffer unit 16 provided between the image forming unit 12 and the pre-processing unit 14 and adjusting a transfer amount or the like of the resin film F fed from the pre-processing unit 14 to the image forming unit 12.

The image forming apparatus 10 includes a post-processing unit 18 accommodating the resin film F discharged from the image forming unit 12, and a buffer unit 20 provided between the image forming unit 12 and the post-processing unit 18 and adjusting a transfer amount or the like of the resin film F discharged from the image forming unit 12 to the post-processing unit 18.

An example of the resin film of the first embodiment of the present invention is made from polyethylene terephthalate and has a thickness of 15 μm and a width of 508 mm.

### [Image Forming Unit]

The image forming unit 12 includes image forming parts 26Y, 26M, 26C and 26K as an examples of image forming parts of yellow (Y), magenta (M), cyan (C) and black (K), and a fixing device 30. Meanwhile, in the following explanation, in a case where Y, M, C and K do not need to be distinguished, Y, M, C and K are abbreviated in some cases.

The each image forming part 26 includes an image support member 36, a charging roller 38 for charging the surface of the image support member 36, and an exposing device 42 for irradiating light for exposure to the charged image support member 36.

The each image forming part 26 further includes a developing device 40 for developing an electrostatic latent image formed on the image support member 36 by the exposure performed by the exposing device 42 to visualize it as a toner image, and a transfer roller 44 for transferring the toner image formed on the image support member 36 to the resin film F.

### [Pre-Processing Unit]

The pre-processing unit 14 includes a feeding roller 22 to which the resin film F to be fed to the image forming unit 12 is wound, as shown in FIG. 8, and the feeding roller 22 is rotatably supported by a frame member not shown in the figure.

### [Main Part]

The post-processing unit 18 includes a winding device 24 for winding the resin film F on which an image has been formed.

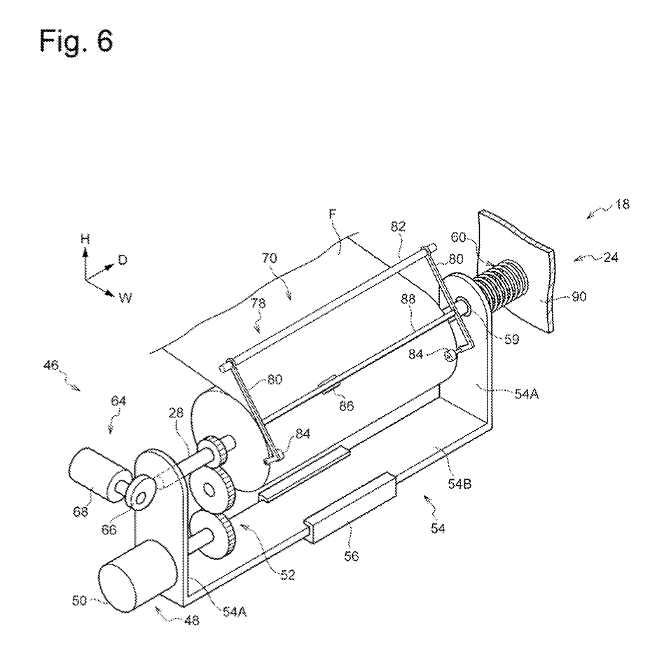

The winding device 24 includes, as shown in FIG. 6, a winding shaft 28 as an example of a winding part for winding the resin film F on which an image has been formed, and a projection portion suppressing member 46 as a suppressing portion for suppressing of formation of a projection portion 100 (see FIG. 1) on the resin film F wound by the winding shaft 28. The winding device 24 further includes a rotation part 48 for rotating the winding shaft 28, and a projection portion measurement member 70 as an example of a measurement member for measuring a projection height (S) of the projection portion 100.

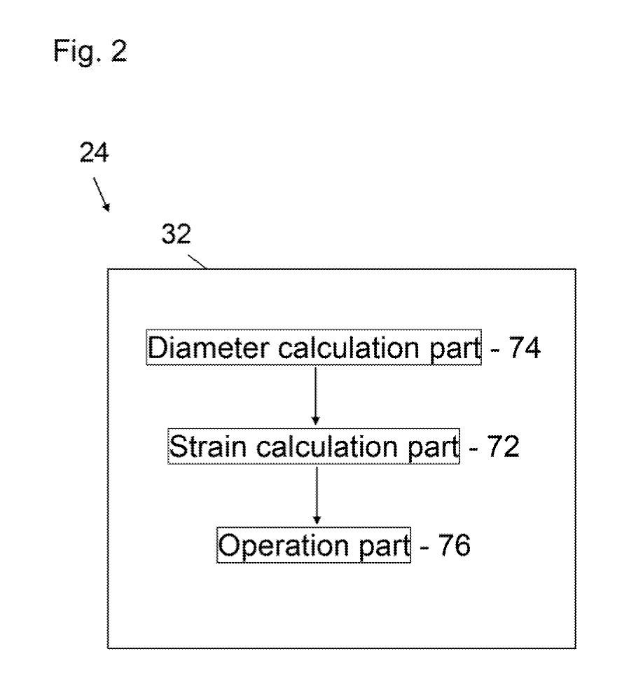

The winding device 24 also includes a control member 32 for controlling each member as shown in FIG. 2. The control member 32 includes a strain calculation part 72 for calculating a strain generated in the resin film F due to the projection portion 100 formed on the resin film F, a diameter calculation part 74 for calculating a diameter of the resin film F wound by the winding shaft 28, and an operation part 76 for operating the projection portion suppressing member 46.

The reason for formation of the projection portion 100 on the resin film is described below. An image part 102 on the resin film F, in which an image has been formed, becomes thicker than a non-image part 104, in which an image was not formed, as shown in FIG. 1. In a case where each image part 102 overlaps at the same position in the shaft direction when the resin film F is wound by the winding shaft 28, the overlapped portion projects with respect to the other portions. By forming the projection portion 100 on the surface of the resin film F wound by the winding shaft 28, the resin film is partially strained. Thus, such a strain is left in the resin film F as a wrinkle.

### [Winding Shaft]

The winding shaft 28 is provided so as to extend to the depth direction of the device as shown in FIG. 6. In other words, the shaft direction of the winding shaft 28 corresponds to the depth direction of the device.

### [Projection Portion Suppressing Member and Rotation Member]

The projection portion suppressing member 46 includes, as shown in FIG. 6, a support member 54 for supporting the both ends of the winding shaft 28, and a guide part 56 for supporting the support member so that the support member 54 is movable to the depth direction of the device. The projection portion suppressing member 46 further includes a biasing spring 60 for biasing the support member 54 at the front side of the depth direction of the device (i.e., left side in FIG. 6), and a cum part 64 for reciprocating the support member in the depth direction of the device.

The support member 54 includes a pair of vertical plates 54A sandwiching the resin film F wound by the winding shaft 28 in the depth direction of the device, and a linking plate 54B linking the lower ends of the pair of vertical plates 54A and extending to the depth direction of the device. The winding shaft 28 is supported, at the both end sides thereof, by the pair of vertical plates 54A via a bearing 59.

The guide part 56 supports the linking plate 54B of the support member 54 from the lower side and makes the support member 54 movable to the depth direction of the device.

The biasing spring 60 is provided between a frame member 90 at the far side (i.e., right side in FIG. 6) of the depth direction of the device with respect to the support member 54 and the vertical plate 54A at the far side of the depth direction of the device for biasing the support member 54 to the front side of the depth direction of the device.

The cum part 64 is provided at the front side of the depth direction of the device with respect to the support member 54 and includes a cum member 66 of which the surface is in contact with the vertical plate at the front side of the depth direction of the device, and a motor 68 for rotating the cum member 66.

The rotation part 48 includes a motor 50 equipped with the vertical plate 54A at the front side of the depth direction of the device, and a gear group 52 that transmits a rotational force of the motor 50 to the winding shaft 28.

In this configuration, in a case where the motor 50 makes the winding shaft 28 rotate to wind the resin film F, the motor 68 rotates the cum member 66. By rotating the cum member 66, the support member 54 and the winding shaft 28 supported by the support member 54 can reciprocate to the depth direction of the device. Then, the winding shaft 28 reciprocating to the depth direction of the device winds the resin film F. In this case, in the resin film F wound by the winding shaft 28, the image portion 102 in which an image has been formed does not overlap at the same position in the shaft direction (see FIG. 1). Thus, formation of the projection portion on the surface of the resin film F wound by the winding shaft 28 is likely to be suppressed.

### [Projection Portion Measurement Member]

The projection portion measurement member 70 includes, as shown in FIG. 6, a measurement instrument 86, which is a so-called laser displacement gage 3, arranged to face the resin film F wound by the winding shaft 28, and a rail member 88 for guiding the measurement instrument 86 in the depth direction of the device. The projection portion measurement member 70 further includes a driving member not shown in the figure, which moves the measurement instrument 86 along the rail member 88 from one end to the other end of the rail member 88.

The projection portion measurement member 70 also includes a swing part 78 for moving the measurement instrument 86 in an approaching and separating direction with respect to the resin film F so that a distance between the measurement instrument 86 and the resin film falls within a specific range.

The swing part 78 includes a pair of support bars 80 extending to a direction crossing the rail member 88 and arranged at the both ends of the rail member 88, and a rotation shaft 82 that is arranged at each one end of the support bars 80, extends to the depth direction of the device, and supports the pair of the support bars 80.

Each of the support bars 80 is bent at the other side into L-shape. The rollers 84 are arranged at the tip end of the portion bent into L-shape to be in contact with the both end.

In this construction, the driven member moves the measurement instrument 86 from one end to the other end of the rail member 88 per a fixed time. That is, the measurement instrument 86 moves from one end to the other end of the wound resin film F. The measurement instrument 86 detects the presence or absence of the projection portion (see FIG. 1) and measures a projection height (S) of the projection portion 100 of the resin film F in the depth direction of the device (width direction of the resin film F).

### [Control Member]

The control member 32 includes a diameter calculation part 74 for calculating a diameter of the resin film F, a strain calculation part 72 for calculating a strain generated in the resin film F due to the projection portion formed on the resin film F, and an operation part 76 for operating the projection portion suppressing member 46.

### [Diameter Calculation Part]

The diameter calculation part 74 always calculates a wound diameter (Rn) of the resin film F from a length (L) of the resin film F wound by the winding shaft 28, a thickness (tn) of the resin film F, and a half diameter (r) of the winding shaft 28 (see FIG. 1). Here, the wound diameter (Rn) means a half diameter of the resin film F in the non-image portion 104 that an image was not formed.

Specifically, a user inputs the thickness (tn) of the resin film and the half diameter (r) of the winding shaft into the winding device from an input part not shown in the figure, and thereby the diameter calculation part 74 obtains the diameter (tn) and the half diameter (r). Also, a transfer rate of the resin film F is predetermined, and the control member 32 obtains it. The diameter calculation part 74 calculates the length (L) of the resin film F wound by the winding shaft from the transfer rate (V) of the resin film F and a time measured with a timer not shown in the figure.

The diameter calculation part 74 can calculate the wound diameter (Rn) of the resin film F from the following equation (1).

Rn=\sqrt{r²+(L·tn)/π} Equation (1)

### [Strain Calculation Part]

The strain calculation part 72 calculates a strain (ε) of the resin film F at the projection portion 100 from the projection height (S) of the projection portion 100 measured by the projection portion measurement member 70, and the winding diameter (Rn) of the resin film F calculated by the diameter calculation part 74.

Specifically, the strain calculation part 72 calculates the strain (ε) of the resin film F at the projection portion 100 from the following equation (2).

ε=S/Rn Equation (2)

### [Operation Part]

The operation part 76 operates the projection portion suppressing member 46 in a case where the strain (ε) calculated from the strain calculation part 72 is a predetermined threshold value or more.

This threshold value is set so that even when the resin film F is partially strained due to the projection portion 100 formed on the resin film F, the strain does not become wrinkle (permanent deformation).

Even in a case where the strain (ε) becomes less than the threshold value during operation of the projection portion suppressing member 46, the operation part 76 goes on operating the projection portion suppressing member 46.

### (Operation)

Subsequently, an operation of the winding device 24 will be explained while comparing to a winding device 200 according to a first comparative example.

The winding device 24 winds the resin film F on which an image has been formed when the image forming apparatus 10 operates, and transfers the resin film F along a transferring path 58 (see FIGS. 6 and 8). Specifically, the motor 50 of the winding device 24 rotates the winding shaft 28, and the rotated winding shaft 28 transfers the resin film F along the transferring path 58. Then, an image is formed on the resin film F by the each image forming part 26 of each color, and the winding shaft 28 winds the resin film on which an image has been formed by rotation.

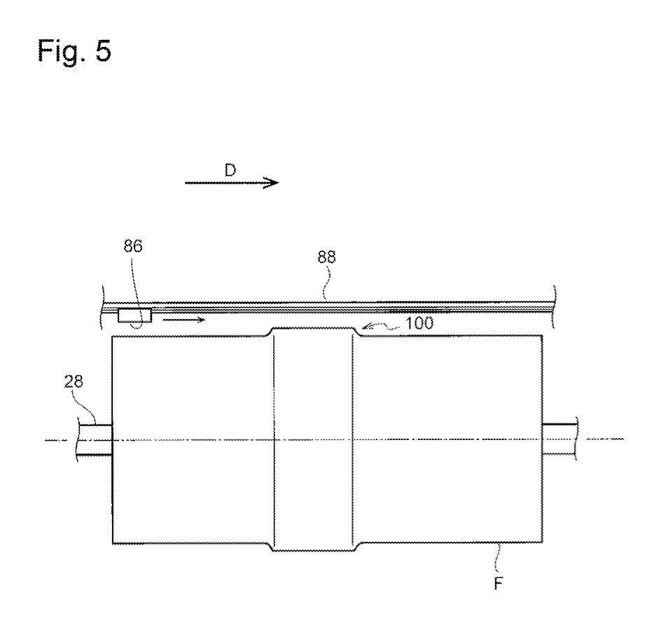

Also, the driving member not shown in the figure moves the measurement instrument 86 from one end to the other end of the rail member 88 per a fixed time as shown in FIG. 5 in order for the measurement instrument 86 to measure the projection amount (S) of the projection portion 100 of the resin film F (see FIG. 1).

The strain calculation part 76 calculates a strain (ε) of the resin film from the projection height (S) measured by the measurement instrument 86, and the wound diameter (Rn) of the resin film F calculated by the diameter calculation part 74.

The operation part 76 operates the projection portion suppressing member 46 in a case where the strain (ε) is the predetermined threshold value or more. By this, the motor 68 shown in FIG. 6 operates and rotates the cum member 66. Further, by rotating the cum member 66, the support member 54 and the winding shaft 28 supported by the support member 54 reciprocate in the depth direction of the device. The winding shaft 28 reciprocating in the depth direction of the device winds the resin film F until the image firming apparatus 10 stops.

Thus, the winding shaft 28 reciprocating in the depth direction of the device winds the resin film F, and thereby in the resin film F wound by the winding shaft, an image part 102 on which an image has been formed does not overlap at the same position in the shaft direction. Due to this, the projection portion 100, which is a factor of wrinkle, is suppressed from being formed at the surface of the resin film F wound by the winding shaft 28.

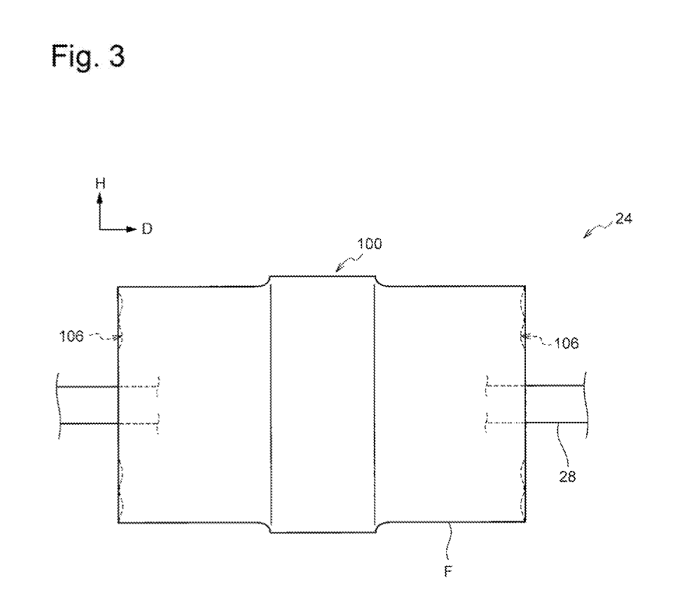

Since the winding shaft 28 winds the resin film F while reciprocating in the depth direction of the device, the both end surfaces 106 of the resin film F wound by the winding shaft 28 is arranged to be non-uniform as shown in FIG. 3.

In the ease where the strain (ε) is less than the predetermined threshold value, the winding shaft 28 does not move in the depth direction of the device. For that, the both end surfaces 106 of the resin film F wound by the winding shaft 28 is arranged to be uniform.

Here, in the winding device 200 according to the first comparative embodiment, in a case where the image forming apparatus 10 operates, the motor 68 shown in FIG. 6 operates, and the winding shaft 28 reciprocates in the depth direction of the device. The winding shaft 28 reciprocating in the depth direction of the device winds the resin film F unit the image forming apparatus stops.

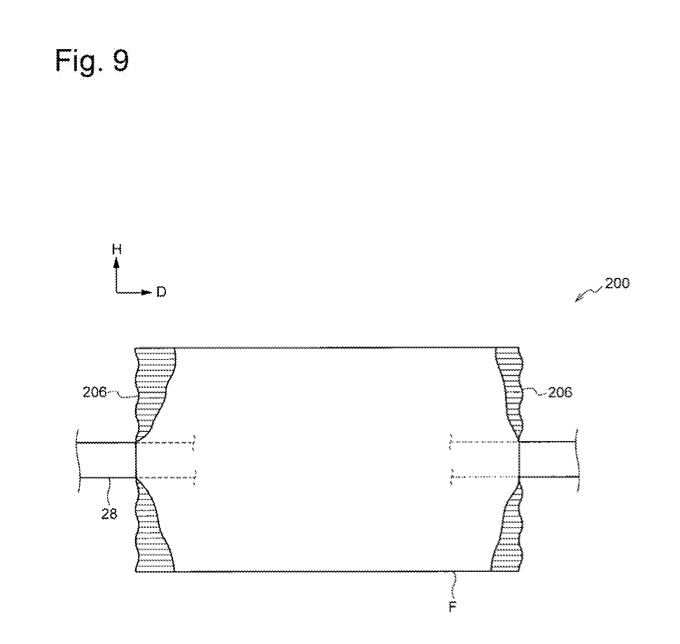

Thus, in the winding device 200, the winding shaft 28 winds the resin film while always reciprocating in the depth direction of the device, and therefore the both end surfaces 206 of the resin film F are arranged to be non-uniform from the start of the winding to the end of the winding as shown in FIG. 9.

### (Summary)

As explained above, the winding device 24 operates the projection portion suppressing member 46 in a case where the strain (ε) of the projection portion 100 is a predetermined threshold value or more. In other words, in an only case where there is a possibility that the projection portion 100, which is a factor of wrinkle, is formed on the wound resin film F, the operation part 76 operates the projection portion suppressing member 46. That is, in an only case where there is a possibility that a strain is generated in the wound resin film F, the projection portion suppressing member 46 operates.

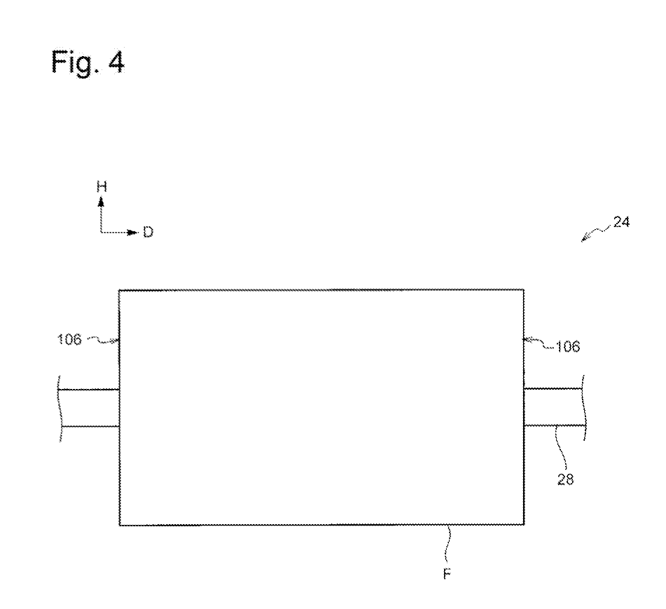

In a case where there is no possibility that the projection portion 100, which is a factor of wrinkle, is formed, the operation part 76 does not operate the projection portion suppressing member 46. In this case, as shown in FIG. 4, the both end surfaces 106 of the resin film F wound by the winding shaft 28 are arranged to be uniform. Due to the uniform arrangement, for example, cut failure in a slit process for cutting margin sections of the both end of the resin film F in the width direction may be suppressed, compared to a case where the both end surface 206 are arranged to be non-uniform from the start to the end of the winding (see FIG. 9).

The projection portion measurement member 70 measures the projection height (S) of the resin film F by using the measurement instrument 86, and therefore a strain of the projection portion 100 (ε) is measured with a high accuracy compared to a case of calculating the projection height (S) of the projection portion 100.

In the image forming apparatus 10, in an only case where there is a possibility that the projection portion 100, which is a factor of wrinkle, is formed on the wound resin film F, the operation part 76 operates the projection portion suppressing member 46. Thus, compared to a case where the projection portion always operates, consumption energy is reduced.

### Second Embodiment

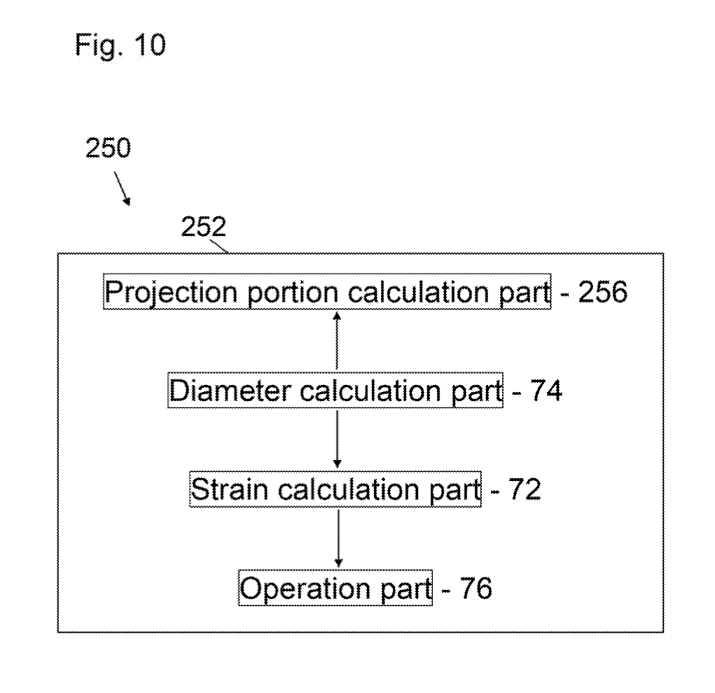

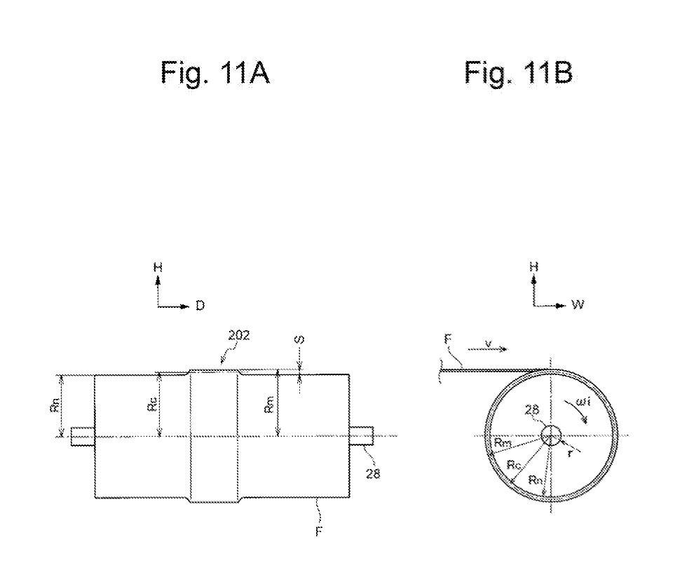

Examples of a winding device and an image forming apparatus according to the second embodiment of the present invention will be explained according to FIGS. 10 and 11. With respect to the same members as in the first embodiment, the same reference signs are used and explanation of the members is omitted, and difference points from the first embodiment will be mainly explained.

A winding device 250 according to the second embodiment does not include a projection portion measurement member, and a control member 252 of the winding device 250 includes the projection portion calculation part 256 as shown in FIG. 10. The winding device 250 further includes a speed meter for measuring rational speed (ωi), the speed meter not shown in the figure. Meanwhile, the rotational speed (ωi) is changed in order for a transfer rate (V) of the resin film F to fall within a predetermined range.

The projection portion calculation part 256 obtains a wound diameter (Rc) by using the following equation (3) from the rotational speed (ωi) of the winding shaft 28, and the transfer rate (V) of the resin film F (see FIG. 11). As shown in FIGS. 11A and 11B, in a case where the wound diameter of the resin film F at the projection portion 202 is set to a wound diameter (Rm), a wound diameter (Rc) is between the wound diameter (Rm) and the wound diameter (Rn).

Rc=V/ω1 Equation (3)

Further, the projection portion calculation part 256 calculates a projection height (S) of the projection portion 202 from the following equation (4).

S=(Rc−Rn)*2 Equation (4)

In this construction, the strain calculation pan 72 calculates a strain (ε) of the resin film F from the projection height (S) calculated by the projection portion calculation part 256, and the wound diameter (Rn) of the resin film F.

As explained above, the projection portion calculation part 256 calculates the projection height (S) of the projection portion 202 by using the rotational speed (ωi) of the winding shaft 28, and the transfer rate (V) of the resin film F. That is, the projection portion calculation part 256 calculates the projection height (S) without using an apparatus such as the projection portion measurement member 70 of the first embodiment. By this, compared to a case where the projection height (S) of the projection portion 100 is measured, a strain (ε) of the projection portion 100 may be obtained by a simple construction.

The other operations of the second embodiment are the same as in the first embodiment, except an operation that the projection portion 202 is measured by using the measurement instrument 86.

The first and second embodiments of the present invention have been explained in detail, but the present invention is not limited thereto. It is apparent to a person skilled in the art that various modifications can be available without exceeding the range of the present invention. For example, the wound diameter (Rn) of the resin film F is calculated by the diameter calculation part 74 in the above embodiments, but the wound diameter may be directly measured by using a laser displacement meter or the like.

Also, a particular explanation has not been made in the first and second embodiments, when the resin film F is wound by the winding shaft 28, an air layer is present between the resin films in sonic cases. In this case, a thickness of the resin film F may be considered as a total thickness of the resin film F and the air layer and may be used for calculation.

In the first and second embodiments, the projection portions 102 and 202 formed by the presence of an image have been explained particularly, but a projection portion may be formed, for example, due to deformation caused by heating the resin film F.

In the first and second embodiments, the resin film F is made from polyethylene terephthalate, but the resin film F may be made from polypropylene, polystyrene, or the like.

In the first and second embodiments, a recording medium is the resin film F, but the recording medium may be paper or the like.

In the first and second embodiments, the winding shaft 28 reciprocating in the depth direction of the device winds the resin film F, and thereby formation of the projection portion 100 or 202 on the resin film F is suppressed. However, for example, the formation of the projection portion 100 or 202 on the resin film F may be suppressed by controlling a wound tension of the winding device (specifically, when the tension is weaken, the effect of the present invention can be obtained). Also, the projection portion suppressing member may issue a warning to notify a user a possibility that the projection portion 100 or 202 may be formed. Due to this warning, the user operates the winding shaft 28 to reciprocate in the shaft direction so as to suppress the formation of the projection portion 100 or 202 on the resin film.

In the first and second embodiments, an image is formed on the resin film F by an electrographic method, but an inkjet method, a gravure method or the like may be available to form an image.

### Third Embodiment

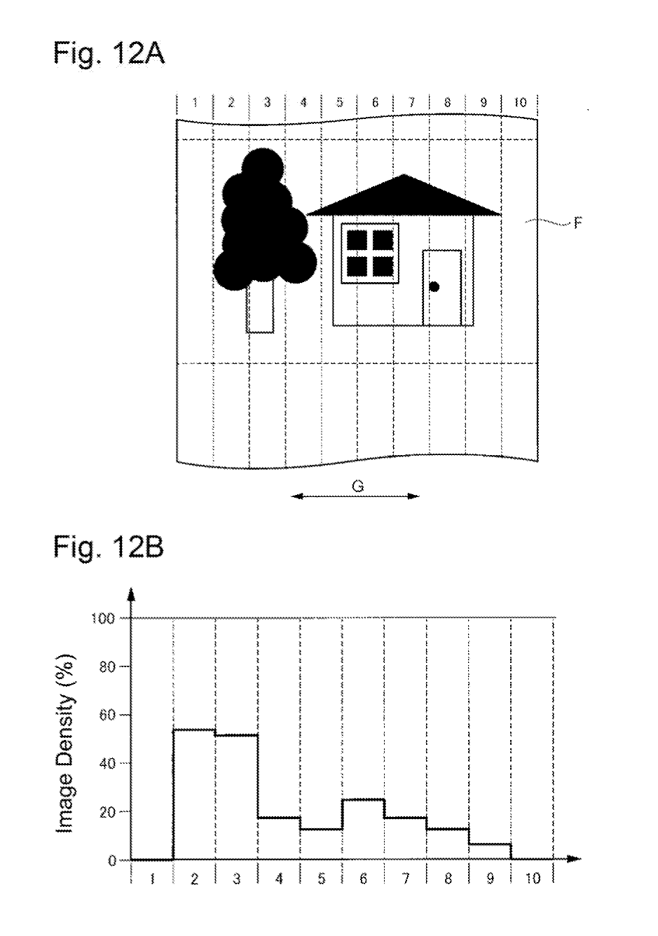

An example of an image forming apparatus according to the third embodiment of the present invention will be explained according to FIGS. 12 to 19. The arrows H, W and D shown in the figures mean a vertical direction of the device, a width direction of the device, and a depth direction of the device, respectively.

### (Whole Construction)

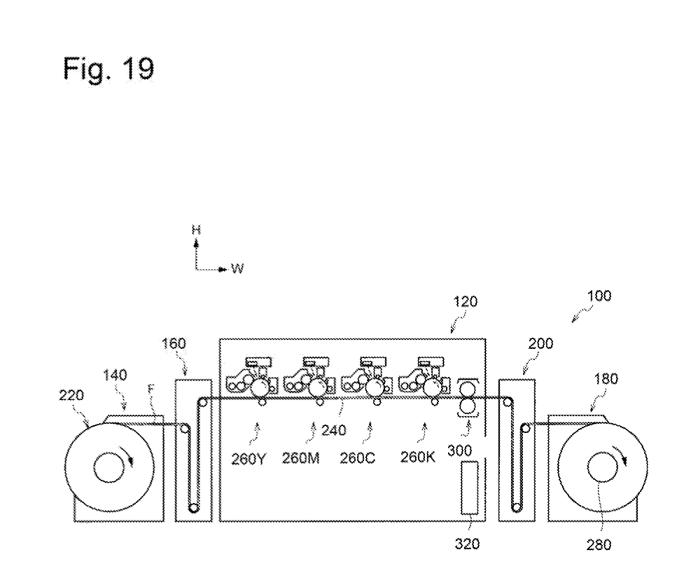

As shown in FIG. 19, an image forming apparatus 100 includes an image forming unit 120 capable of forming an image a resin film F as a longitudinal recording medium, a pre-processing unit 140 accommodating the resin film F to be fed to the image forming unit 120, and a buffer unit 160 provided between the image forming unit 120 and the pre-processing unit 140 and adjusting a transfer amount or the like of the resin film F fed from the pre-processine. unit 140 to the image forming unit 120.

The image forming apparatus 100 includes a post-processing unit 180 accommodating the resin film F discharged from the imam forming unit 120, and a buffer unit 200 provided between the image forming unit 120 and the post-processing unit 180 and adjusting a transfer amount or the like of the resin film F discharged from the image forming unit 120 to the post-processing unit 180. The image forming apparatus 100 also includes a control member 320 as an example of operation part for controlling each part.

An example of the resin film of the first embodiment of the present invention is made from polyethylene terephthalate and has a thickness of 15 μm and a width of 508 mm.

### [Image Forming Unit]

The image forming unit 120 includes image forming parts 260Y, 260M, 260C and 260K as an examples of image forming parts of yellow (Y), magenta (M), cyan (C) and black (K), and a fixing device 300. Meanwhile, in the following explanation, in a case where Y, M, C and K do not need to be distinguished, Y, M, C and K are abbreviated in some cases.

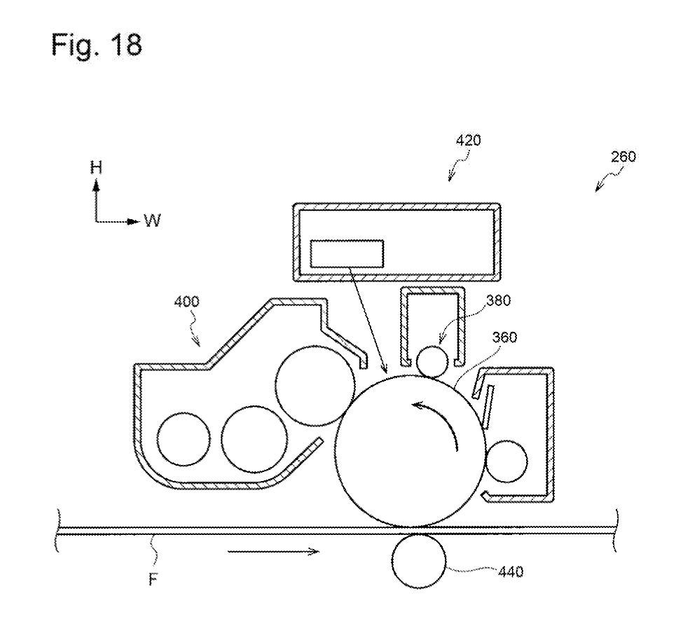

The each image forming part 260 includes, as shown in FIG. 18, an image support member 360, a charging roller 380 for charging the surface of the image support member 360, and an exposing device 420 for irradiating light for exposure to the charged image support member 360.

The each image forming part 260 further includes a developing device 400 for developing an electrostatic latent image formed on the image support member 360 by the exposure performed by the exposing device 420 to visualize it as a toner image, and a transfer roller 440 for transferring the toner image formed on the image support member 360 to the resin film F. Also, the fixing device 300 (see FIG. 19) is capable of fixing a toner image to the resin film F.

### [Pre-processing Unit]

The pre-processing unit 140 includes a feeding roller 220 to which the resin film F to be fed to the image forming unit 120 is wound, as shown in FIG. 19, and the feeding roller 220 is rotatably supported by a frame member not shown in the figure.

### [Main Part]

The post-processing unit 180 includes a winding shaft 280 as one example of a winding part extending to the depth direction of the device and being capable of winding the resin film F on which an image has been formed, by receiving a rotational force from a motor not shown in the figure.

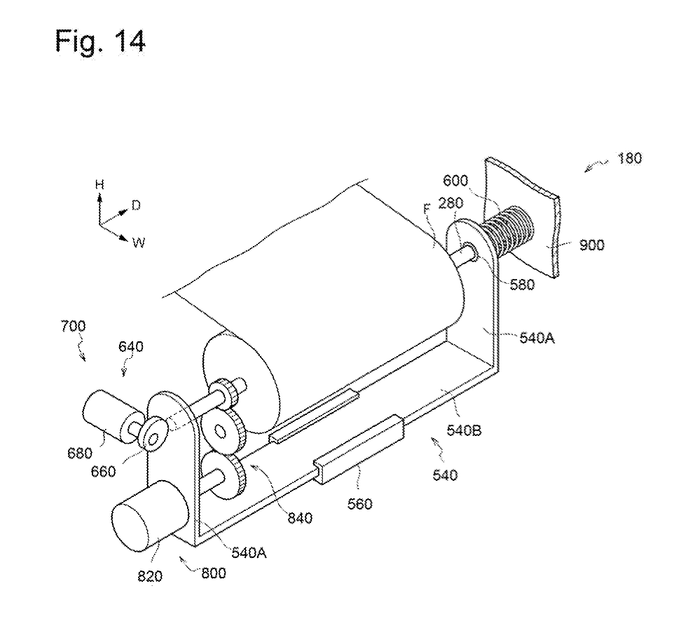

The post-processing unit 180 includes, as shown in FIG. 14, a support member 540 for supporting the both ends of the winding shaft 280, and a guide part 560 for supporting the support member so that the support member 540 is movable to the depth direction of the device. The post-processing unit 180 further includes a biasing spring 600 for biasing the support member 540 at the front side of the depth direction of the device (i.e., left side in figure), and a cum part 640 for reciprocating the support member in the depth direction of the device, and a rotation part 800 for rotating the winding shaft 280.

The support member 540 includes a pair of vertical plates 540A sandwiching the resin film F wound by the winding shaft 280 in the depth direction of the device, and a linking plate 540B linking the lower ends of the pair of vertical plates 540A and extending to the depth direction of the device. The winding shaft 280 is supported, at the both end sides thereof, by the pair of vertical plates 540A via a bearing 580.

The guide part 560 supports the linking plate 540B of the support member 540 from the lower side and makes the support member 540 movable to the depth direction of the device.

The biasing spring 600 is provided between a frame member 900 at the far side (i.e., right side in figure) of the depth direction of the device with respect to the support member 540 and the vertical plate 540A at the far side of the depth direcfion of the device for biasing the support member 540 to the front side of the depth direction of the device.

The cum part 640 is provided at the front side of the depth direction of the device with respect to the support member 540 and includes a cum member 660 of which the surface is in contact with the vertical plate at the front side of the depth direction of the device, and a motor 680 making the cum member 660 rotate.

The rotation part 800 includes a motor 820 equipped with the vertical plate 540A at the front side of the depth direction of the device, and a gear group 840 that transmits a rotational force of the motor 800 to the winding shaft 280.

The suppressing member 700 for suppressing the formation of the projection portion (described later in detail) on the resin film F includes the guide member 560, the biasing spring 600 and the cum part 640.

Control of the motor 820 and suppressing member 700 performed by the control member 320 will be explained together with operation of the image forming apparatus according to the third embodiment of the present invention.

### (Operation)

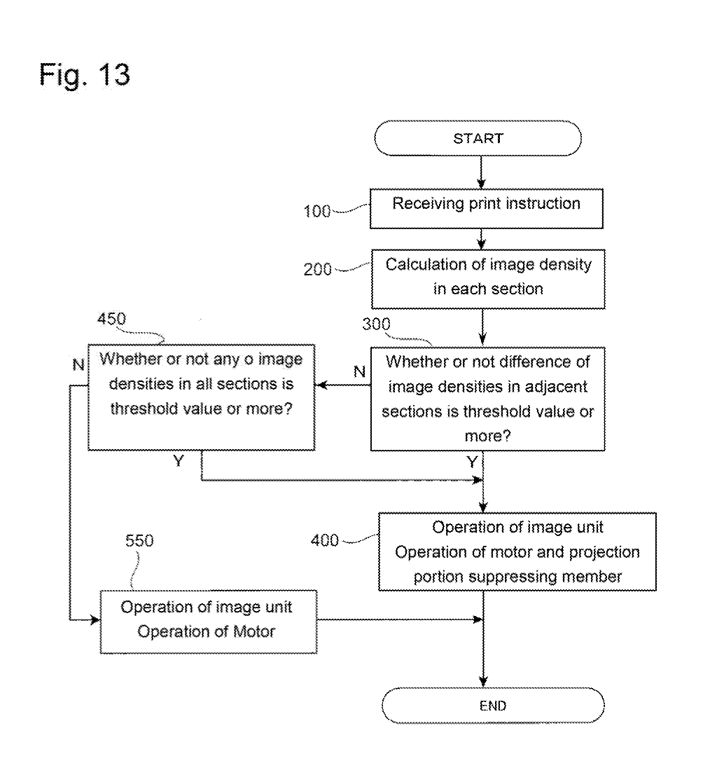

Subsequently, an operation of the image forming apparatus 100 will be explained by using the flow diagram of FIG. 13, while comparing to the image forming apparatus 3000 according to a second comparative embodiment. With respect to the image forming apparatus 3000, different points from the image forming apparatus 100 will be mainly explained.

In a case Where an image is formed on the resin film F, the control member 320 receives one print instruction (ono print job) for forming a plurality of images on the resin film F at the step 100. After the control member 320 receives the one print instruction, the flow proceeds to the step 200.

At the step 200, the control member 320 calculates an image density in each section into which the resin film F is divided in the width thereof based on image data output by the one print instruction. The image density means a ratio of colored dots to the total dots in the region, and in a case of the total dots in the region are colored (beta-image), the ratio is 100%.

For example, the control member 320 divides image data for forming one image as shown in FIG. 12A on the resin film F into 100 sections in the width direction of the resin film F (6 direction in the figure). And then, the control member 320 calculates an individual image density of the one image in each section as shown in FIG. 12B. The control member 320 calculates the individual image densities in all divided sections with respect to all images output by the one print instruction. Then, the control member 320 calculates an image density in each section based on the individual image densities of all images output by the one print instruction.

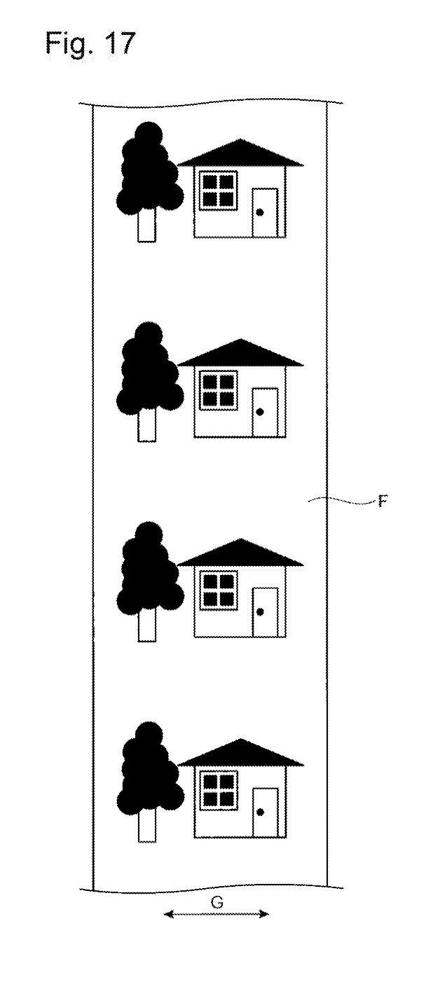

After the control member 32 calculates the image density in each section, the flow proceeds to the step 300. Meanwhile, in the working examples, a plurality of images output by the one print instruction is the image shown in FIG. 12A (see FIG. 17).

In the step 300, the control member 320 compares image densities in adjacent sections to each other and determines the difference of their image densities is equal to or greater than a threshold value or not. In the case where the difference is equal to or greater than the threshold value or more, the control member 320 determines that there is a possibility that a projection portion is formed on the resin film F. Here, the projection portion means a projection portion formed on the resin film F wound by the winding shaft 280 and extending to the circumferential direction of the wound resin film F due to difference of the image densities of an image which has been formed on the resin film F (step in the width direction of the resin film). Specifically, at a portion where an image density is high, a thickness thereof becomes thicker than a portion where an image density is low. In a case where the resin film F is wound by the winding shaft so that the portion where an image density is high overlaps at the same position in the shaft direction, a projection portion extending to the circumferential direction of the wound resin film F is formed on the resin film F. And then, the projection portion leads to a partial strain of the resin film F. when the resin film F is taken out from the winding shaft 280, this strain remains in the resin film F as a wrinkle in some cases.

In the case where the difference of the image densities in adjacent sections is equal to or greater than the threshold value or more, the flow proceeds to the step 400, and in the case where the difference of the image densities in adjacent sections is less than the threshold value, the flow proceeds to the step 450.

In the step 400, the control member 320 operates the image forming unit 120 of each color (see FIG. 19). The control member 320 also operates the motor 820 and the suppressing member 700 (see FIG. 14).

By this, the motor 820 rotates the winding shaft 280, the rotated winding shaft 280 finds the resin film F. Further, the motor equipped with the suppressing member 700 rotates the com member 660, and the rotated cum member 660 makes the support member 540 and the winding shaft 280 supported by the support member 540 reciprocate.

Thus, by reciprocating the winding shaft in the depth direction of the device, a margin for overlapping, in the shaft direction, regions in which image densities are high becomes small. By this, the formation of the projection portion on the resin film F is suppressed.

Then, all images output by the one print image are formed on the resin film F. After the winding shaft 280 winds the resin film F on which the images have been formed, the control member 320 completes the operation for forming an image.

Thus, the winding shaft 280 winds the resin film F while reciprocating in the depth direction of the device, and therefore the both end surfaces 1060 of the resin film F wounded by the winding shaft 280 are arranged to be non-uniform.

On the other hand, as explained above, in the case where the difference of the image densities in adjacent sections is less than the threshold value or more, the flow proceeds to the step 450.

In the step 450, the control member 320 determines whether any of image densities in the sections is equal to or greater than a threshold value. By this, in the case where any of image densities in the sections is equal to or greater than the threshold value, the control member 320 determines that there is a possibility that a projection portion is thrilled on the resin film F.

In the case where any of image densities in the sections is equal to or greater than the threshold value, the flows proceeds to the step 400, and in the step 400, the above explained process is performed. On the other hand, in the case where image densities of the all sections are less than the threshold value, the flow proceeds to the step 550.

In the step 550, the control member 320 operates the image forming unit 120 of each color (see FIG. 19). The control member 320 further operates the motor 820 (see FIG. 14). The control member 320 does not operate the suppressing member 700.

By this, the motor 82 rotates the winding shaft 28, and the rotated winding shaft 28 winds the resin film F. Then, all images output by the one print instruction are formed on the resin film F. After the winding shaft 280 winds the resin film F on which the images have been formed, the control member 320 completes the operation for forming an image.

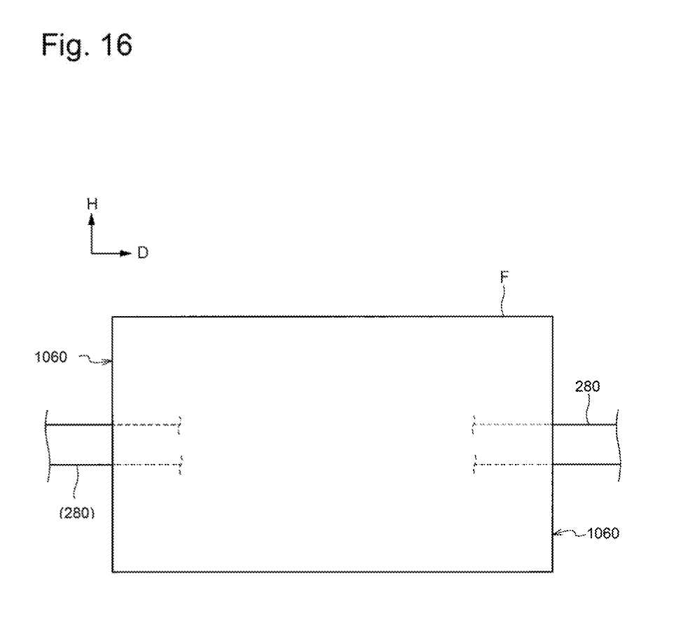

Thus, the winding shaft 280 not reciprocating in the depth direction of the device winds the resin film F, and therefore the both end surfaces 1060 of the resin film F wound by the winding shaft 280 are arranged to be uniform as shown in FIG. 16. In other words, in a case where there is a low possibility that a projection portion is formed on the resin film F, the winding shaft 280 not reciprocating in the depth direction of the device winds the resin film F, and thereby the both end surfaces 1060 of the resin film F are arranged to be uniformed.

Here, in an image forming apparatus according to the comparative embodiment, a control member (omitted in the figure) operates the image forming unit 120 of each color (see FIG. 19) when receiving one print instruction for forming a plurality of images on the resin film F. Further, the control member operates the motor 680 and the suppressing member 700 (see FIG. 14).

By this, the winding shaft 28 reciprocating in the depth direction of the device winds the resin film F. Then, all images output by the one print instruction are formed on the resin film F. After the winding shaft 280 winds the resin film F on which the images have been formed, the control member completes the operation for forming an image.

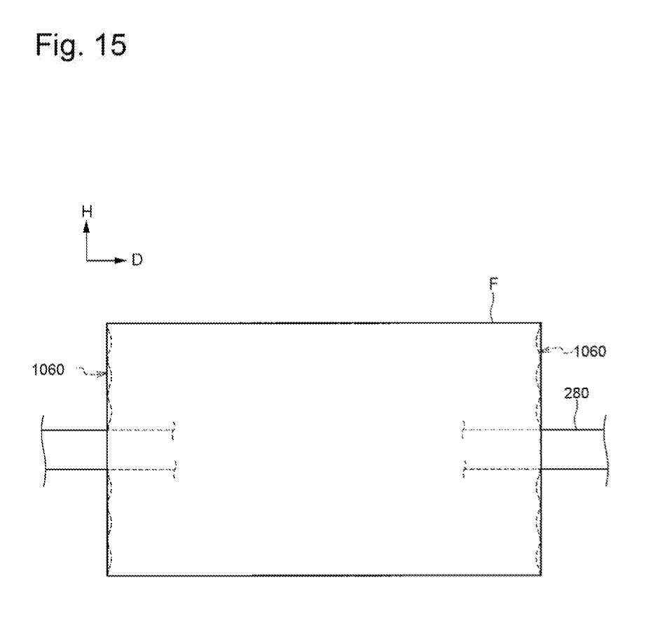

Thus, in the image forming apparatus according to the second comparative embodiment, the winding shaft 280 winds the resin film while reciprocating in the depth direction of the device, and therefore the both end surfaces 1060 of the resin film F are always arranged to be non-uniform regardless of image density (see FIG. 15). Due to such non-uniform arrangement, for example, eut failure in a slit process for cutting margin sections of the both end of the resin film F in the width direction is caused in some cases.

### (Summary)

As explained above, the control member 320 in the image forming apparatus 100 determines, in the step 300, whether or not the difference of image densities of adjacent sections is a threshold value or more. The control member 320 also determines, in the step 450, whether or not the image densities in the any of sections are a threshold value or more. In the case where the control member 320 determines there is a possibility that a projection portion is formed on the resin film F, the control member 320 operates the suppressing member 700.

On the other hand, in the case where the control member determines there is no possibility that a projection portion is formed on the resin film F, the control member 320 does not operate the suppressing member 700. Thus, the control member 320 determines there is no possibility that a projection portion is formed on the resin film, the both end surfaces 106 of the resin film F wound by the winding shaft 280 are arranged to be non-uniform as shown in FIG. 16. Due to such a non-uniform arrangement, for example, cut failure in a slit process for cutting margin sections of the both end of the resin film F in the width direction may be suppressed compared to the case of uniform arrangement.

On contrary, in an image forming apparatus according to the second comparative embodiment, the winding shaft 280 reciprocating in the depth direction of the device winds the resin film F, and therefore the both end surfaces 1060 of the resin film F wound by the winding shaft 280 are always arranged to be non-uniforin regardless the image density. In other words, in the image forming apparatus according to the second comparative example imparts, the winding shaft 280 winds the resin film F while reciprocating in the depth direction of the device even in a case where there is low possibility that a projection portion is formed on the resin film F, and therefore the both end surfaces 1060 are always arranged to be non-uniform. On the other hand, in the image forming apparatus 100, in the case where the control member 320 determines there is no possibility that a projection portion is formed on the resin film F, as explained above, the both end surfaces 1060 of the resin film F are arranged to be uniform. Thus, in the case where there is low possibility that a projection portion is formed on the resin film F, the non-uniform arrangement of the both end surfaces of the resin film F is suppressed.

The control member 320 determines, in the step 450, there is a possibility that a projection portion is thrmed on the resin film F in a case where any of image densities in the sections is a threshold value or more. Thus, since the control member 320 determines the possibility of the formation of the projection portion on the resin film F based on the image density in each section, the possibility of the formation of the projection portion on the resin film F is determined in higher accuracy compared to a case where the suppressing member operates only when the diMrence of image densities in adjacent sections is a threshold value or more.

The third embodiment of the present invention has been explained in detail, but the present invention is not limited thereto. It is apparent to a person skilled in the art that various modifications can be available without exceeding the range of the present invention. For example, in the third embodiment, a plurality of images is formed on the resin film F by one print instruction, but only one image may be formed on the resin film F by one print instruction.

In the third embodiment, all of the plurality of images formed on the resin film F by one print instruction are the same, but the plurality of images thrmed on the resin film F by one print instruction may be different.

Also, in the third embodiment, the image forming apparatus determines there is a possibility that a projection portion is formed on the resin film F based on difference of image densities in adjacent sections, but for example, the image forming apparatus may determine there is a possibility that a projection portion is formed on the resin film F by comparing the highest image density and the lowest image density among all image densities in the sections.

In the first and second embodiments, the resin film F is made from polyethylene terephthalate, but the resin film F may be made from polypropylene, polystyrene, or the like.

In the first and second embodiments, a recording medium is the resin film F, but the recording medium may be paper or the like.

In the first and second embodiments, the winding shaft 280 reciprocating in the depth direction of the device winds the resin film F. However, for example, the suppressing member may issue a warning to notify a user a possibility that a projection portion is formed. Due to this warning, the user operates the winding shaft 280 to reciprocate in the shaft direction so as to suppress the formation of the projection portion on the resin film.

In the third embodiment, the control member 320 divides image data into 10 sections in the width direction of the resin film F (G direction in the figure), but the divided section may be 10 or more or less than 10.

In the third embodiment, an image is formed on the resin film F by an electrographic method, but an inkjet method, a intaglio printing method or the like may be available to form an image.

In the third embodiment, the control member 320 determines, in the step 450, whether or not any of image densities in the sections is a threshold value or more, but in the case where the difference of image densities in adjacent sections is less than a threshold value in the step 300, the flow may directly proceed to the step 550.

### Fourth Embodiment

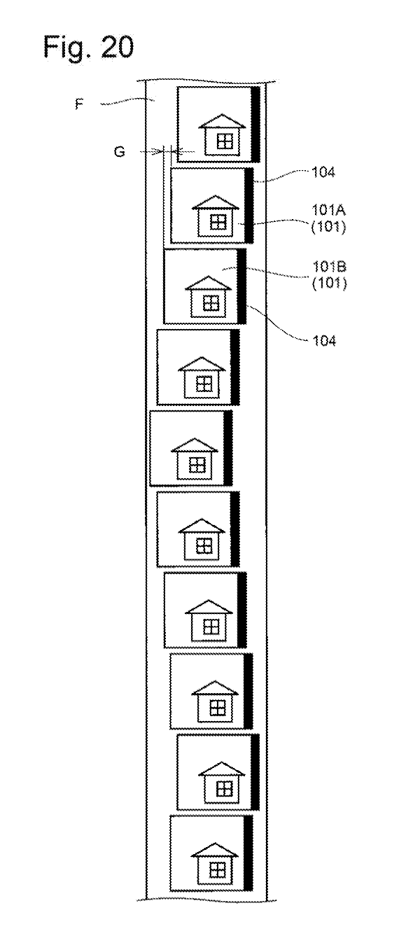

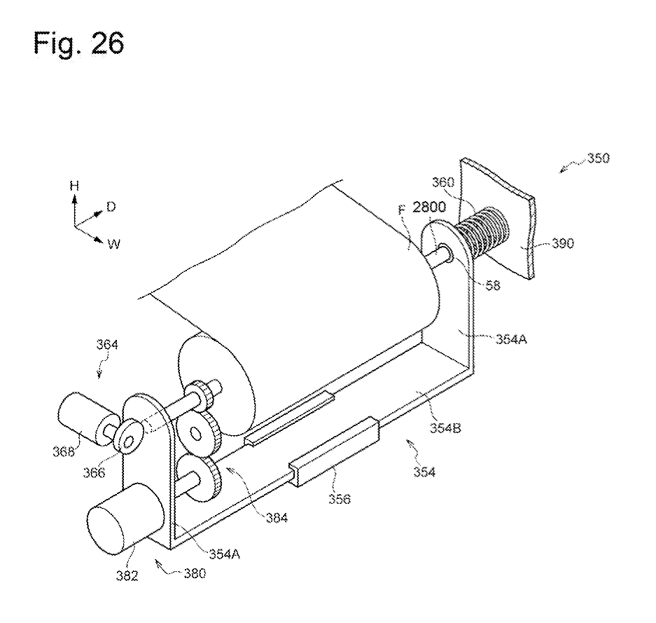

An example of an image forming apparatus according to the fourth embodiment of the present invention will be explained according to FIGS. 20 to 26. The arrows H, W and D shown in the figures mean a vertical direction of the device, a width direction of the device, and a depth direction of the device, respectively.

### (Whole Construction)

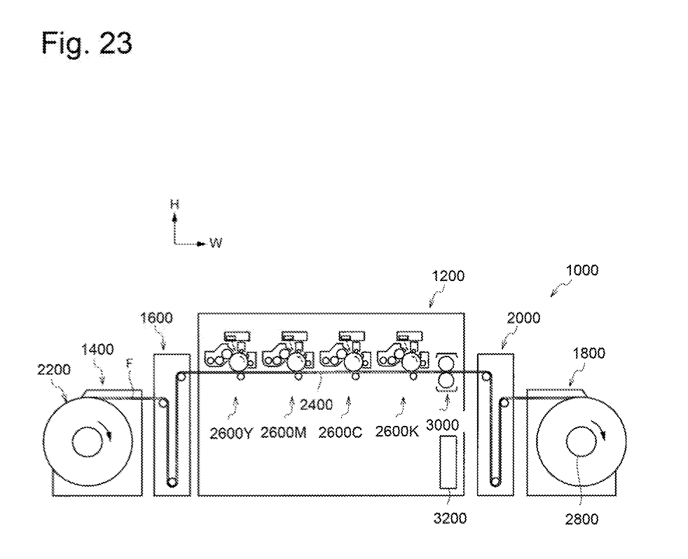

As shown in FIG. 23, an image forming apparatus 1000 includes an image forming unit 1200 capable of forming an image a resin film F as a longitudinal recording medium, a pre-processing unit 1400 accommodating the resin film F to be fed to the image forming unit 1200, and a buffer unit 1600 provided between the image forming unit 1200 and the pre-processing unit 1400 and adjusting a transfer amount or the like of the resin film F fed from the pre-processing unit 1400 to the image forming unit 1200.

The image forming apparatus 1000 includes a post-processing unit 1800 accommodating the resin film F discharged from the image forming unit 1200, and a buffer unit 2000 provided between the image forming unit 1200 and the post-processing unit 1800 and adjusting a transfer amount or the like of the resin film F discharged from the image forming unit 1200 to the post-processing unit 1800.

### [Image Forming Unit]

The image forming unit 1200 includes image forming parts 2600Y, 2600M, 2600C and 2600K as an examples of image forming parts of yellow (Y), magenta (M), cyan (C) and black (K), and a fixing device 3000. Meanwhile, in the following explanation, in a case where Y, M, C and K do not need to be distinguished, Y, M, C and K are abbreviated in some cases.

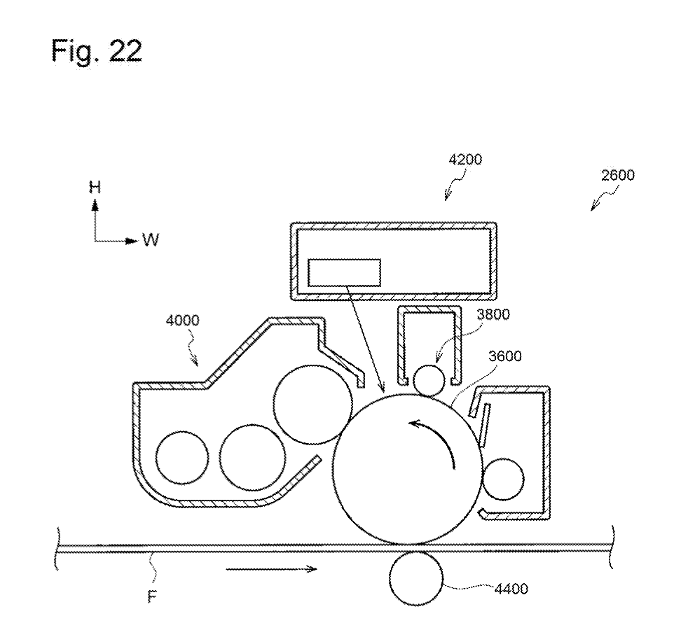

The each image forming part 2600 includes, as shown in FIG. 22, an image support member 3600, a charging roller 3800 for charging the surface of the image support member 3600, and an exposing device 4200 for irradiating light for exposure to the charged image support member 3600.

The each image forming part 2600 further includes a developing device 4000 for developing an electrostatic latent image formed on the image support member 3600 by the exposure performed by the exposing device 420 to visualize it as a toner image, and a transfer roller 4400 for transferring the toner image formed on the image support member 3600 to the resin film F. Also, the fixing device 3000 (see FIG. 23) is capable of fixing a toner image to the resin film F.

A position of an image formed on the resin film F by each image forming part 2600 of each color will be explained below in detail.

### [Pre-processing Unit]

The pre-processing unit 1400 includes a feeding roller 2200 to which the resin film F to be fed to the image forming unit 1200 is wound, as shown in FIG. 23, and the feeding roller 2200 is rotatably supported by a frame member not shown in the figure.

### [Post-processing Unit]

The post-processing unit 1800 includes a winding shaft 2800 as one example of a winding part capable of winding the resin film F on which an image has been formed, by receiving a rotational fbrce from a motor not shown in the figure.

In this construction, by rotating the winding shaft 2800, a tension in a paper-feeding direction is imparted to the resin film F, and thereby the resin film F is fed to a transferring path 2400.

### (Main Part)

Subsequently, a position of an image formed on the resin film F by each image forming part 2600 of each color will be explained. An example of the resin film of the first embodiment of the present invention is made from polyethylene terephthalate and has a thickness of 15 μm and a width of 508 mm.

The image forming part 2600 forms a latter image 101B by being shifted in the width direction of the resin film F with respect to a former image 101A.

Specifically, the image forming part 2600 shifts a position of an electrostatic latent image formed on an image support member 3600 by an exposure device (see FIG. 22) in the depth direction of the device, and thereby the latter image 101B is shifted in the width direction of the resin film F with respect to the former image 101A. As one example of the fourth embodiment, all of images 101 are the same and have a high image density portion 104 in which an image density is high at one end side in the width direction of the image 101.

The image forming part 2600 forms a plurality of images on the resin film F while being shifted in a wavy tbrm (for example, sine-curve shape, zigzag shape). As one example of the fourth embodiment, amplitude of the wavy form is in a range of 2 mm or more and 10 mm or less. In the case where the amplitude is less than 2 mm, effects for suppression of formation of a projection portion become small as explained below, and in the case where the amplitude is more than 10 mm, a problem is caused during a slit process or the like, which is a post-processing, in some cases. Further, a period of the wavy form is a length of the resin film F wounded by 10 rotations (initial 10 rotations) of the winding shaft 28.

A shifted amount (size G in FIG. 20) of the latter image 101B with respect to the former image 101A is set to become large as the resin film F is soft, by the control member not shown in the figure. In other words, in a ease where an image is formed on a softer resin film F than a resin film F (hereinafter referred to as a harder resin film F), the shifted amount in the case of using the softer resin film F is larger than the shifted amount in the case of using the harder resin film F. Meanwhile, a softness of the resin film F is input from an input part by an user, and is received by the control member.

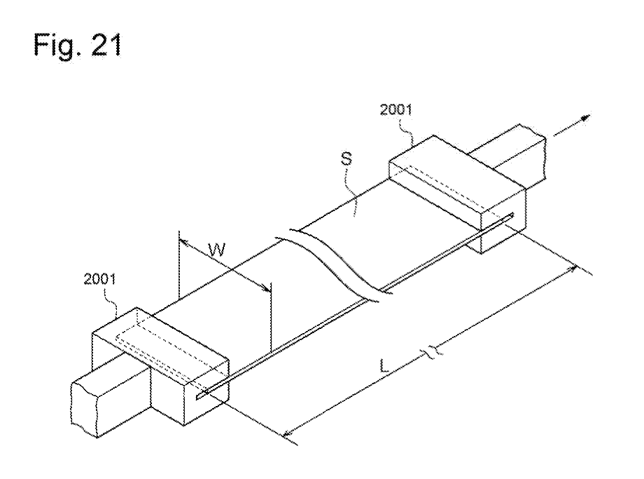

Here, the softness of the resin film F is compared based on an elongation of the resin film F. Specifically, a test piece S with a length (L) of 150 mm and a width (W) of 15 mm is cut out from the resin film F (see FIG. 21). As shown in FIG. 21, the both ends portion of the test piece in the longitudinal direction thereof are griped by grip members 200. A tensile load is imparted to the test piece S by 1.0 N through the grip members 200 so that the test piece S is elongated in the longitudinal direction. After such an elongation of the test piece S, a resin film F with a larger elongation is defined as “softer” than a resin film with a smaller elongation.

### (Operation)

In the image forming apparatus according to the fourth embodiment, an operation obtained by the formation of the latter image 101B by being shifted in the width direction of the resin film F with respect to the former image 101A on the resin film F will be explained.

Initially, constructions and operations of an image forming apparatus 300 according to the third comparative embodiment and an image forming apparatus 350 according to the fourth comparative embodiment will be explained. With respect to the image forming apparatuses 300 and 350 according to the third comparative embodiment and the fourth comparative embodiment, respectively, differences from the fourth embodiment of the present invention will be explained mainly.

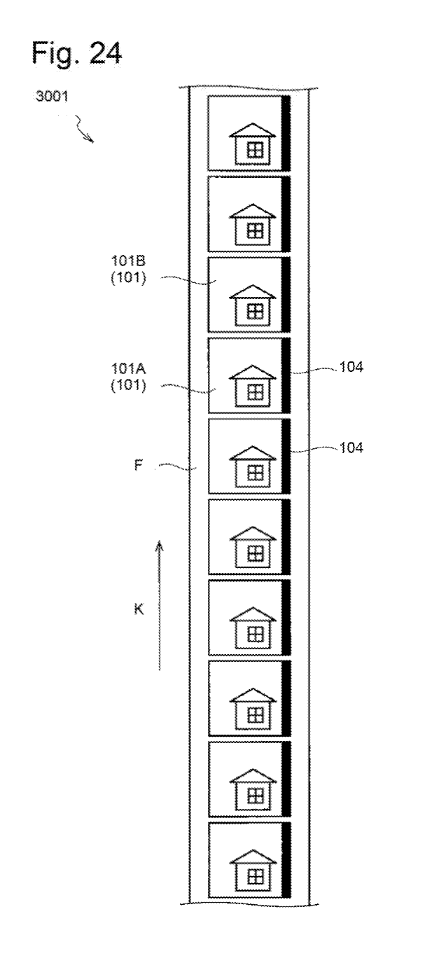

In the image forming apparatus 300 according to the third comparative embodiment, the latter image 100B is not shifted in the width direction of the resin film with respect to the former image 101A, as shown in FIG. 24.

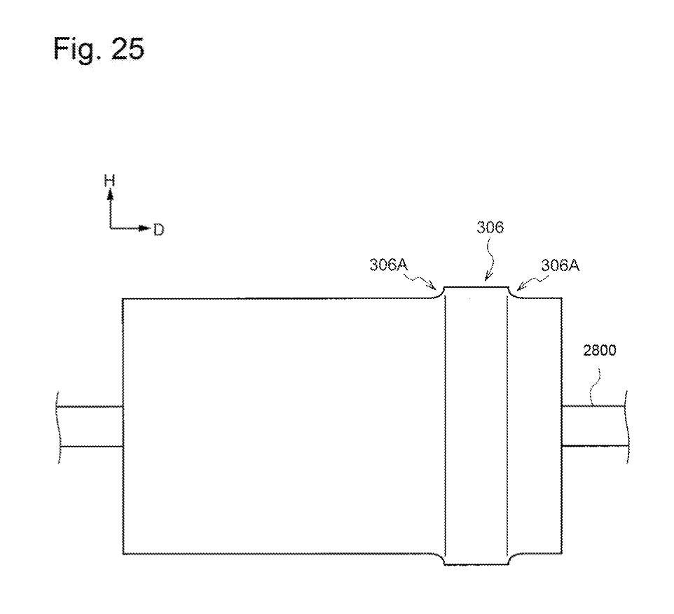

Due to this construction, a projection portion 306 is formed on the surface of the resin film F wound by the winding shaft, as shown in FIG. 25. The reason for formation of the projection portion 306 is that the high image density portion 104 in each image 101 becomes thicker than the other portion, and the high image density portion 104 in each image 101 is overlapped at the same position in the shaft direction when the resin film is wound by the winding shaft 2800.

Thus, the projection portion 306 is formed on the surface of the resin film wound by the winding shalt, and owing to the both end portions 306A of the projection portion 306, the resin film F is strained. When the resin film F is taken out from the winding shaft 2800 after completion of image forming operation, this strain remains on the resin film F as a wrinkle.

The image forming apparatus 350 according to the fourth comparative embodiment, the latter image 101B is not shifted in the width direction of the resin film with respect to the former image 101A, as shown in FIG. 24. Further, the winding shaft 2800 of the image forming apparatus 350 is capable of reciprocating in the depth direction of the device.

Specifically, the image forming apparatus 350 includes a support member 354 for supporting portions at the both end sides of the winding shaft 2800, and a rail member 356 for supporting the support member 354 so that the support member 354 is movable in the depth direction of the device. Further, the image forming apparatus 350 includes a biasing spring 360 for biasing the support member 354 to the front side (left side in the figure) in the depth direction of the device, a cum part 364 for reciprocating the support member in the depth direction of the device, and a rotation part 380 for rotating the winding shaft 2800.

The support member 354 includes a pair of vertical plates 354A sandwiching the resin film F wound by the winding shaft 2800 in the depth direction of the device, and a linking plate 354B for linking the lower ends of the pair of vertical plates 354A and extending to the depth direction of the device. The winding shaft 2800 is supported, at the both end sides thereof, by the pair of vertical plates 354A via a bearing not shown in the figure.

The rail part 356 supports the linking plate 354B of the support member 354 from the lower side and makes the support member 354 movable to the depth direction of the device.

The biasing spring 360 is provided between a frame member 390 at the far side (i.e., right side in the figure) of the depth direction of the device with respect to the support member 354 and the vertical plate 354A at the far side of the depth direction of the device for biasing the support member 354 to the front side of the depth direction of the device.

The cum part 364 is provided at the front side of the depth direction of the device with respect to the support member 354 and includes a cum member 366 of which the surface is in contact with the vertical plate at the front side of the depth direction of the device, and a motor 368 for rotating the cum member 366.

The rotation part 380 includes a motor 382 equipped with the vertical plate 354A at the front side of the depth direction of the device, and a gear group 384 that transmits a rotational tbrce of the motor 382 to the winding shaft 28.

In this construction, in a case where the motor 382 makes the winding shaft 2800 rotate to wind the resin film F, the motor 368 rotates the cum member 366. By rotating the cum member 366, the support member 354 and the winding shaft 2800 supported by the support member 354 can reciprocate to the depth direction of the device. Then, the winding shaft 28 reciprocating to the depth direction of the device winds the resin film F.

Thus, by winding the resin film F by the winding shaft 2800 reciprocating in the depth direction of the device (as one example, the amplitude is 2 mm), in the resin film wound by the winding shaft, the high image density portion 104 in each image does not overlap at the same position in the shaft direction. By this, the formation of the projection portion on the surface the resin film F wound by the winding shaft 2800 is likely to be suppressed.

However, since the winding shaft 28 reciprocating in the depth direction of the device winds the resin film F. the both end surfaces of the resin film F wound by the winding shaft 2800 are arranged to be non-uniform.

The image forming part 2600 in the image forming apparatus of the fourth embodiment forms the latter image 1018 by being, shifted in the width direction of the resin film with respect to the former image 101A on the resin film F, as shown in FIG. 20. In detail, the image forming part 2600 forms the latter image 101B by being shifted in the width direction of the resin film with respect to the former image 101A on the resin film F transferred to one direction extending the resin film F without being shifted in the width direction of the resin film F.

Then, the winding shaft 2800 in the image forming apparatus winds the resin film F without moving in the depth direction of the device.

Due to this, in the resin film F wound by the winding shaft 2800, the high image density portion 104 (see FIG. 20) in each image does not overlap at the same position in the shaft direction. Thus, the formation of the projection portion on the surface of the resin film F wound by the winding shaft 2800 is likely to be suppressed. Further, the winding shaft does not move in the depth direction of the device, and therefore the non-uniform arrangement of the both end surfaces width direction end surface) of the resin film F is suppressed.

### (Summary)

As explained above, the image forming apparatus 1000 forms the latter image 101B by being shifted in the width direction of the resin film F with respect to the former image 101A on the resin film F. By this, the non-uniform arrangement of the width direction end surfaces of the wound resin film F is suppressed compared to a case where the resin film F on which an image has been formed is wound while shifting the resin film F in the width direction thereof.

The image forming part 2600 forms each image 101 while being shifted in the width direction of the resin film F on the resin film F. By this, the formation of the projection portion on the wound resin film F is suppressed compared to a case where images are irregularly shifted.

As explained above, in the case where an image is formed on the softer resin film F, the shifted amount when the softer resin film is used is set to be larger. By this, in the case where the softer resin film F is used, an overlapping margin of the high image density portion 104 in the shaft direction in the resin film F wound by the winding shaft 2800 becomes small than the case where a relatively hard resin film is used. Thus, a projection height of the projection portion formed when the softer resin film F is used becomes small, a strain of the resin film F generated from the projection portion is suppressed. It is considered that the largest shifted amount when using the softest resin film F among the all kinds of the resin films F is applied, but in the case where the shifted amount is large, a problem is caused during a slit process or the like, which is a post-processing, in some cases.

By this, with respect to a resin film F in which the shifted amount may be small, it is preferable that the shifted amount is not set to large.

As explained above, the image forming part 2600 can shift the latter image 101B in the width direction of the resin film F with respect to the former image 101A by shifting a position of an electrostatic latent image formed on the image support member 3600 by the exposure device 4200. Thus, the latter image 101B can be shifted with respect to the former image 101A with a more simple construction compared to the case of transferring the resin film F while being shifted in the width direction of the resin film F without shifting the position of the electrostatic latent image firmed on the image support member 3600.

The fourth embodiment of the present invention has been explained in detail, but the present invention is not limited thereto. It is apparent to a person skilled in the art that various modifications can be available without exceeding the range of the present invention. For example, in the fourth embodiment, the resin film F is made from polyethylene terephthalate, but the resin film F may be made from polypropylene, polystyrene, or the like.

In the fourth embodiment, a recording medium is the resin film F, but the recording medium may be paper or the like.

In the fourth embodiment, an image is formed on the resin film F by an electrographic method, but an inkjet method, a gravure method or the like may be available to form an image.

In the fourth embodiment, as one example, all images 101 are the same, but the images 101 may be different.

In the fourth embodiment, the image forming part 2600 forms each image 101 on the resin film F by being shifted in the width direction of the resin film F in a wavy form, but each image 101 may not be shifted in a wavy form.

In the fourth embodiment, the image forming parts shifts the latter image 101B in the width direction of the resin film F with respect to the former image 101A by shifting the position of the electrostatic latent image formed on the image support member 3600 by the exposure device 4200. However, for example, in a ease where only one image forming part 26 is provided, the latter image 101B may be shifted in the width direction of the resin film F with respect to the former image 101A by transferring the resin film F in a wavy form.

In the fourth embodiment, in the case where an image is formed on a softer resin film F, the shifted amount when using the softer resin film F is set to be larger than the case of using a relatively hard resin film F. However, resin films may be stepwise classified in a predetermined range based on softness of resin films F to determine the shifted amount depending on the classification.

The foregoing description of the exemplary embodiments of the present invention has been provided for the purpose of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and there equivalents.

What is claimed is:

1. A winding device, comprising:
a winding part that winds a longitudinal recording medium in which an image is formed;
a suppressing member that suppresses generation of a strain in the longitudinal recording medium wound by the winding part; and
an operation part that operates the suppressing member in a case where the strain in the longitudinal recording medium wound by the winding part is a threshold value or more.

2. The winding device according to claim 1, further comprising:
a measurement member that measures a projection height of a projection portion formed on a surface the longitudinal recording medium;
a diameter calculation part that calculates a wound diameter of the winding part at which the longitudinal recording medium is wound; and
a strain calculation part that calculates the strain in the longitudinal recording medium wound by the winding part from a measurement result of the measurement member and a calculation result of the diameter calculation part.

3. The winding device according to claim 1, further comprising:
a projection portion calculation part that calculates a projection height of a projection portion formed on a surface of the longitudinal recording medium;
a diameter calculation part that calculates a wound diameter of the winding part at which the longitudinal recording medium is wound; and
a strain calculation part that calculates the strain in the longitudinal recording medium wound by the winding part from a calculation result of the projection portion calculation part and a calculation result of the diameter calculation part.

4. An image forming apparatus, comprising:
an image forming part that forms an image on a longitudinal recording medium; and
the winding device according to claim 1, including the winding part that winds the longitudinal recording medium on which an image is formed by the image forming part.

5. An image forming apparatus, comprising:
an image forming part that forms an image on a longitudinal recording medium; and
the winding device according to claim 2, including the winding part that winds the longitudinal recording medium on which an image is formed by the image forming part.

6. An image forming apparatus, comprising:
an image forming part that forms an image on a longitudinal recording medium; and
the winding device according to claim 3, including the winding part that winds the longitudinal recording medium on which an image is formed by the image forming part.

7. An image forming apparatus, comprising:
an image forming part that forms an image on a longitudinal recording medium;
a winding part that winds the longitudinal recording medium on which an image is fomed by the image forming part:,
a suppressing member that suppresses formation of a projection portion on the longitudinal recording medium wound by the winding part;
an operation part that divides image data for forming an image on the longitudinal recording medium into a plurality of sections in a width direction of the longitudinal recording medium, and that operates the suppressing member in a case where a difference of image densities in adjacent sections is a threshold value or more.

8. The image forming apparatus according to claim 7,
wherein the operation part operates the suppressing member in a case where any image density in all of the plurality of sections is a threshold value or more.

9. The image forming apparatus according to claim 7,
wherein the suppressing member is a transfer member that reciprocates the winding part in the width direction of the longitudinal recording medium.

10. The image fanning apparatus according to claim 8,
wherein the suppressing member is a transfer member that reciprocates the winding part in the width direction of the longitudinal recording medium.

11. An image forming apparatus, comprising:
an image forming part that forms a latter image by being shifted in a width direction of a longitudinal recording medium extending in one direction with respect to a former image in a case where a plurality of images is formed on the longitudinal recording medium; and
a winding part that winds the longitudinal recording medium on which the plurality of images is formed.

12. The image forming apparatus according to claim 11,
wherein the image forming part forms the plurality of images by being shifted in a wavy form.

13. The image forming apparatus according to claim 11,
wherein a shifted amount of image is changed depending on softness of the longitudinal recording medium.

14. The image forming apparatus according to claim 12,
wherein a shifted amount of image is changed depending on softness of the longitudinal recording medium.

15. The image forming apparatus according to claim 13,
wherein in a case where the longitudinal recording medium is softer, the shifted amount of image is set to be larger.

16. The image forming apparatus according to claim 14,
wherein in a case where the longitudinal recording medium is softer, the shifted amount of image is set to be larger.

17. The image forming apparatus according to claim 11,
wherein the longitudinal recording medium is transferred in one direction.

18. The image forming apparatus according to claim 12,
wherein the longitudinal recording medium is transferred in one direction.

19. The image forming apparatus according to claim 13,
wherein the longitudinal recording medium is transferred in one direction.

20. The image forming apparatus according to claim 15,
wherein the longitudinal recording medium is transferred in one direction.
